(19) United States
(12) Patent Application Publication
(10) Pub. No.: US 2023/0062719 A1
(43) Pub. Date: Mar. 2, 2023

(54) Cordless Decorative LED Light for Decorative Items

(71) Applicant: Christine Dodge, Newnan, GA (US)

(72) Inventor: Christine Dodge, Newnan, GA (US)

(21) Appl. No.: 17/898,633

(22) Filed: Aug. 30, 2022

Related U.S. Application Data
(60) Provisional application No. 63/238,393, filed on Aug. 30, 2021.

(51) Int. Cl. F21S 9/02; F21V 17/12; F21V 17/16; F21V 23/04

(52) U.S. Cl. CPC F21S 9/02; F21V 17/12; F21V 17/16; F21V 23/0435; F21Y 2115/10

(57) ABSTRACT

The present invention relates to a LED battery-operated replacement light designed to removably insert into electrical openings in decorative fixtures/items. The light includes an interchangeable LED, a rechargeable battery, and a timer chip. The LED is coupled to the battery for electrical power and the timer chip is configured to store a timer value duration for which the LED remains illuminated. For securing the light in an opening, a metal retention biasing clip is provided that has a pair of tapered legs with graduated indentations such that the LED, battery, and timer chip are inserted along a perimeter of the opening, wherein the legs are initially pushed towards each other to insert along the perimeter of the opening and are then subsequently released for biasing the legs outward to secure the light inside the opening.

### CROSS-REFERENCE TO RELATED APPLICATION

The present application claims priority to, and the benefit of, U.S. Provisional Application No. 63/238,393, which was filed on Aug. 30, 2021 and is incorporated herein by reference in its entirety.

### FIELD OF THE INVENTION

The present invention relates generally to the field of decorative lighting. More specifically, the present invention relates to a novel LED decorative lighting to be used with, for example, Christmas houses, Halloween decorations, nightlights, and more. The lighting is designed for insertion into an existing electrical opening and can be operated via a small ‘ON/OFF’ switch or remote-control. A built-in timer enables a user to program the lighting to run for a predetermined time duration, turning ON and OFF at the same time daily. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals desire to illuminate and decorate their homes, buildings, and businesses during holiday seasons and even every day. Individuals use various light-up decorative items such as pumpkins on front porches for Halloween, ceramic village pieces and trees at Christmas, and more for decoration. Such illuminating decorative items use illuminating sources such as LEDs. Conventional illuminating sources when used in the decorative items use electrical cords for electric supply. When a plurality of decorative items is deployed, a large number of electrical cords are required for creating a specific display using the decorative items. The large number of electrical cords are not only an ugly sight, but are dangerous for children and pets. Further, electrical outlets are limited and may be inadequate for accommodating the large number of cords. In some cases, more than twenty cords are required in a single decorative set up.

Disruption or fault in conventional electrical supply may also cause disappointment to individuals as the illumination display and decorative lighting may be turned off. Individuals desire improved decorative lighting that can be turned on independently from conventional electrical supplies.

In traditional decorative lighting, users are required to manually turn off the lights such as in the morning or during the day by turning OFF the wall mounted outlets. It is a common occurrence for individuals to forget to turn off the lights which not only consumes electricity and increases the electrical bill but is also not environmentally friendly. Individuals desire decorative lighting that can be turned on and off automatically.

Therefore, there exists a long felt need in the art for an improved decorative lighting that can be used without the hassle of electrical cords. There is also a long felt need in the art for an improved decorative lighting that can be designed and used in various holiday seasons. Additionally, there is a long felt need in the art for an improved decorative lighting that can be used with any decorative item for houses, buildings, and businesses. Moreover, there is a long felt need in the art for an improved decorative lighting that can be inserted into an existing electrical opening. Further, there is a long felt need in the art for an improved decorative lighting that can be programmed to run periodically for a specific period of time. Furthermore, there is a long felt need in the art for an improved decorative lighting that is small, compact, and uses energy efficient LEDs. Also, there is a long felt need in the art for an improved decorative lighting that does not depend on the conventional electrical supply for its operation. Finally, there is a long felt need in the art for a decorative lighting that offers an easy way to eliminate display cords which present a tripping hazard while supplying power to decorations.

The subject matter disclosed and claimed herein, in one embodiment thereof, comprises a decorative lighting configured to be used with existing decorative items for illumination. The decorative lighting does not use any electrical cords and has an integrated rechargeable battery for providing electrical power to LEDs. The LEDs illuminated in accordance with a predetermined timer value set in a timer chip and can be operated using a power button or remotely using a remote-control device. The decorative lighting is a type of plug-in light that has a metal retention biasing clip having a pair of tapered legs configured to pull towards each other to insert into a hole disposed in a decorative item and are released to abut the hole wall to secure inside the hole. The LED illuminates the decorative item without any electrical cord.

In this manner, the novel cordless lighting device of the present invention accomplishes all of the forgoing objectives and provides users with decorative light without the hassle of electrical cords. The device can be controlled remotely and illuminates for a predetermined duration. The light is securely placed in any hole sized with a diameter from about 1 inch to about 2 inches and is small, easy to assemble, and does not need electrical cords for power. The light eliminates extensive electrical considerations and overload on an electric outlet.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a LED battery-operated replacement light. The LED light is designed to be used with decorative items such as Christmas houses, Halloween decorations, and nightlights. The LED light further comprising a LED illuminating source held in a plastic cover, a housing for storing a timer chip and a battery, the housing is configured to be closed by the plastic cover such that plastic cover is positioned on the housing. The battery is configured to provide electric power to the LED for illumination and the timer chip is configured to count a time duration for which the LED is illuminated thereby eliminating electrical cords and continuous illumination of the LED. The timer allows turning ON and OFF of the LED at the same time daily. The LED light can be turned on using a power switch disposed on the exterior surface of the housing or remotely using a remote-control device wherein the remote-control device is connected to the lighting device using Bluetooth channel. The light device has a metal retention biasing clip with a pair of legs having graduated indentations attached to the bottom surface of the housing to secure the light device in a hole or an electrical opening in a decorative item.

In yet another embodiment, a cordless LED lighting configured to insert in holes in decorative items for providing illumination is disclosed. The LED lighting includes a housing storing a battery and a timer chip, a plastic cover configured to cover the housing, the plastic cover accommodates a LED, the LED is coupled to the battery for receiving electric power, the timer chip is configured to measure a predetermined time duration during which the LED will illuminate. The LED lighting can be turned on using a power button disposed on the exterior surface of the housing or using a remote-control device. The LED lighting is configured to secure using a metal retention biasing clip having a pair of legs wherein the legs can be pushed towards each other to insert into a hole and is thereafter released to abut with the wall of the hole to secure the LED lighting therein.

In an additional embodiment of the presently described invention, a decorative item is included. The decorative item includes a lighting device inserted into a plurality of holes disposed in the body of the decorative item, the lighting device includes a metal retention biasing clip for securing the device along a perimeter of the hole, a housing for accommodating a timer chip and a battery, a cover for covering the housing and accommodating an LED, the battery is coupled to the LED using a pair of wires, wherein the LED is illuminated for a duration stored in the timer chip.

In a further embodiment of the present invention, the decorative item is at least one of Christmas houses, Halloween decorations, and nightlights.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an LED-operated decorative lighting of the present invention in accordance with the disclosed architecture;

FIG. 2 illustrates an exploded view of the LED-operated decorative lighting of the present invention in accordance with the disclosed architecture;

FIG. 3 illustrates a perspective view showing the LED decorative lighting in an assembled form with the cover being removed to disclose the electrical components in accordance with the disclosed architecture;

FIG. 4 illustrates a perspective view showing the LED lighting device being inserted into a hole of a ceramic display device in accordance with the disclosed architecture;

FIG. 5 illustrates a perspective view of a Christmas village display equipped with a plurality of the decorative lighting of the present invention in accordance with the disclosed architecture; and

FIG. 6 illustrates a schematic view showing connection of the lighting device and a remote-control device for remote operation and control of the lighting device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved decorative lighting that can be used without the hassle of electrical cords. There is also a long felt need in the art for an improved decorative lighting that can be designed and used in various holiday fixtures/seasons. Additionally, there is a long felt need in the art for an improved decorative lighting that can be used with any decorative item for houses, buildings, and businesses. Moreover, there is a long felt need in the art for an improved decorative lighting that can be inserted into an existing electrical opening. Further, there is a long felt need in the art for an improved decorative lighting that can be programmed to run periodically for a specific period of time. Furthermore, there is a long felt need in the art for an improved decorative lighting that is small, compact, and uses energy efficient LEDs. Also, there is a long felt need in the art for an improved decorative lighting that does not depend on the conventional electrical supply for its operation. Finally, there is a long felt need in the art for a decorative lighting that offers an easy way to eliminate display cords which present a tripping hazard in decorations/fixtures.

The present invention, in one exemplary embodiment, is a novel cordless LED lighting configured to insert in holes in decorative items for providing illumination. The LED lighting includes a housing storing a battery and a timer chip, a plastic cover configured to cover the housing, the plastic cover accommodates a LED, the LED is coupled to the battery for receiving electric power, the timer chip is configured to measure a predetermined time period during which the LED will illuminate. The LED lighting can be turned on using a power button disposed on the exterior surface of the housing or using a remote-control device. The LED lighting is configured to secure using a metal retention biasing clip having a pair of legs wherein the legs can be pushed towards each other to insert into a hole and is thereafter released to abut with the wall of the hole to secure the LED lighting.

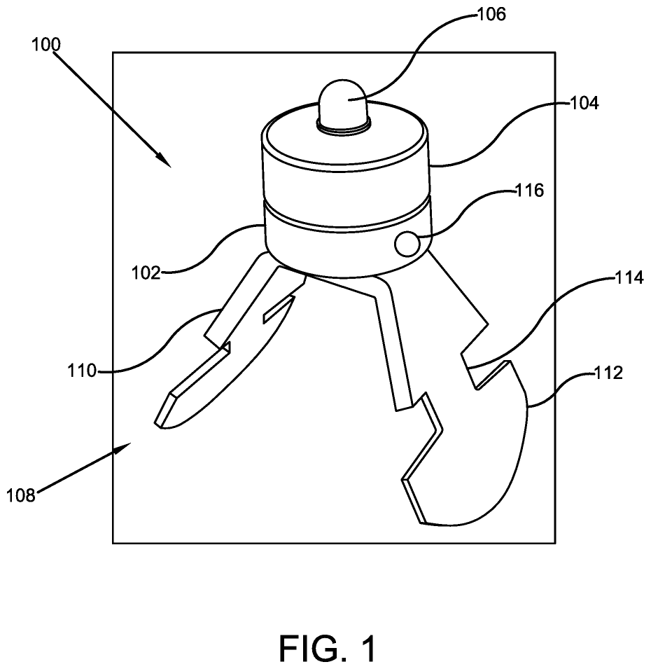

Referring initially to the drawings, FIG. 1 illustrates a perspective view of one potential embodiment of LED-operated decorative lighting of the present invention in accordance with the disclosed architecture. The LED-operated decorative lighting 100 of the present invention is designed as an improved decorative light for use with Christmas houses, Halloween decorations, nightlights, and more. The lighting device 100 can be used independently for illumination and decoration without use of any electrical cord. More specifically, the lighting device 100 is a compact lighting device that can be secured in any, for example, 1-inch to 2-inch sized hole as found in conventional decorative items.

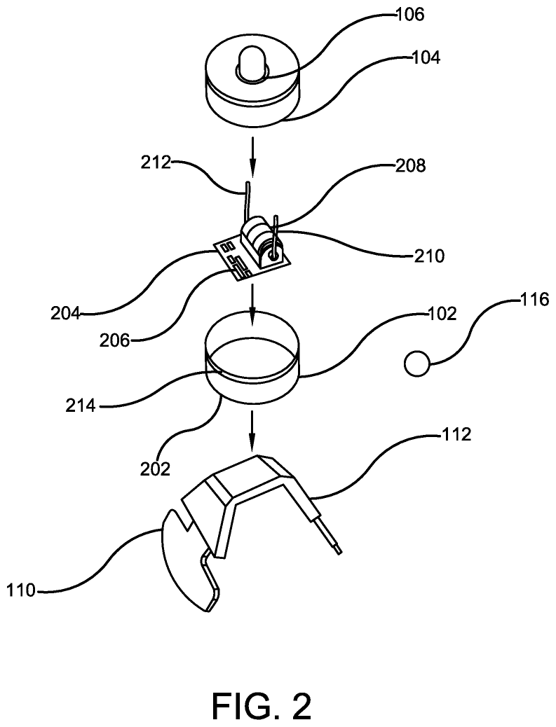

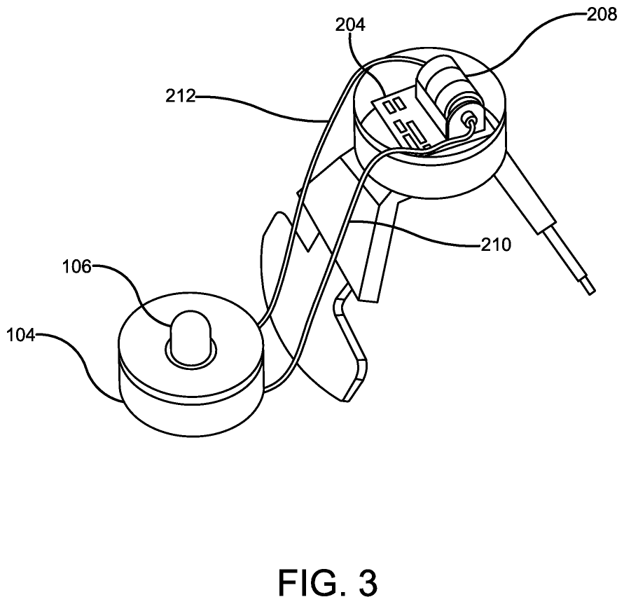

The device 100 includes a housing 102 configured to store electrical components and an LED light as illustrated in FIG. 2. The housing 102 is secured by a plastic cover 104 which is removably positioned and secured on the housing 102 (illustrated in FIG. 3) and the plastic cover 104 includes a replaceable LED light 106 for illumination. The housing 102 and the plastic cover 104 may be secured using a threaded fastener. A metal retention biasing clip 108 having a pair of legs 110, 112 is positioned below the housing 102 and integrally attached to the housing 102 such that the metal retention biasing clip 108 is used for inserting the lighting device 100 into an existing hole or electrical opening inside a decorative item. Each leg 110, 112 has graduated indentations 114 for helping in securing the light 100 in a hole.

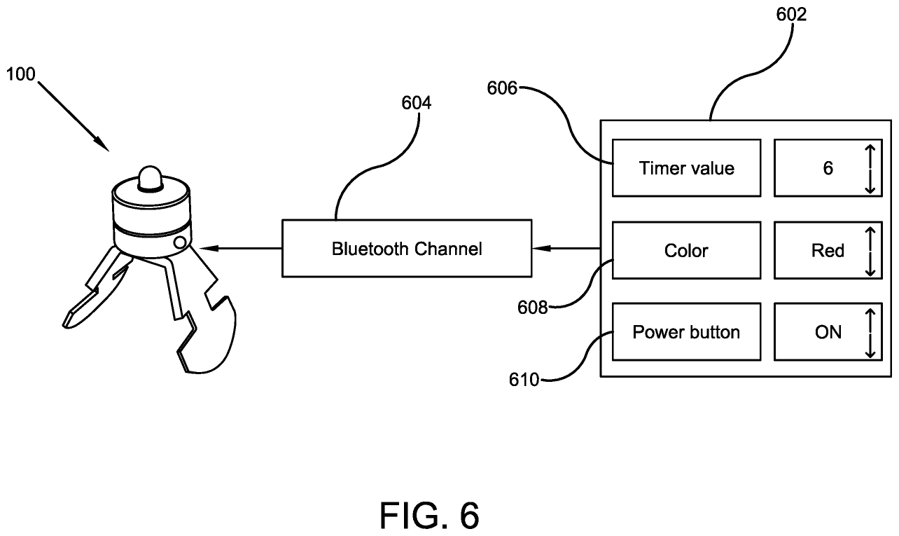

The lighting device 100 can be operated remotely using a remote-control device as described in FIG. 6 or using a small ‘ON/OFF’ switch 116 disposed on exterior surface of the housing 102. The switch 116 is configured to activate/deactivate power supply to the LED 106 for illumination for decoration.

The lighting device 100 is relatively small, compact, easy to assemble, and does not require electrical cords for its operation. The device 100 has improved efficiency and provides a longer operational lifetime over conventional incandescent light sources. Further, due to low constant temperature of LEDs, the lighting device 100 can be used be with all types of decorative items without fear of damage to the items.

FIG. 2 illustrates an exploded view of the LED-operated decorative lighting of the present invention in accordance with the disclosed architecture. The metal retention biasing clip 108 is integrally molded to the bottom surface 202 of the housing 102 such that the legs 110, 112 can be pushed towards each other enabling a user to insert the light 100 into a hole. When the legs 110, 112 are released, they spring or bias open and try to regain their original orientation as illustrated in FIG. 1 to abut the light 100 along a perimeter of the hole or electrical opening.

The housing 102 is made of heavy-duty translucent plastic material and houses a built-in timer chip 204. The built-in timer chip 204 also has an embedded wireless transceiver 206 for enabling a user to configure and control the lighting device 100 using a remote-control. The timer chip 204 can be in the form of a controller, processor, integrated circuit (IC) or application specific integrated circuit (ASIC) and has a relay circuit and is configured to be programmed with a timer value duration for which the lighting device 100 periodically illuminates and allows the LED to turn on and off at the same time daily. The timer chip 204 helps in saving the energy and increasing operational life of LED 106.

The housing 102 also stores a rechargeable battery 208, which is connected to the LED 106 using a pair of wires 210, 212. The rechargeable battery 208 can be in the form of an Li-Ion battery or any other conventional battery and can be accessed by removing the cover 104 for recharging. The battery 208 can have power ranging from about 4V to about 5V and can provide electrical power to the LED 106 for about 100-150 hours, thereby reducing the frequency of charging the battery 208. The housing 102 has a threaded end 214 for securing and tightening the cover 104 for securing the electrical components stored therein.

The cover 104 is made from heavy-duty substantially translucent and dispersing plastic that allows the illumination of the LED 106 to disperse and illuminate a decorative item in which the lighting device 100 is installed. It should be noted the cover 104 encloses the LED 106 for protection from physical damage and the LED 106 can be easily removed from the device 100 when the LED 106 is required to be changed. The LED 106 may come in a single color and can illuminate continuously or in a flashing manner as required and preferred by a user. The LED can be of any desired color including but not limited to red, silver, blue, green, yellow, white, frosted, and more. In some embodiments of the present invention, the housing 102 and the cover 104 can be substantially transparent for enabling complete illumination and not blockage of light emitted by the LED 106.

The lighting device 100 can be used both indoors and outdoors as the cover 104 seals the housing 102 when placed and screwed on the housing 102. As a result, the device 100 is substantially waterproof, water resistant, and sealed. The metal retention biasing clip 108 allows the light 100 to be easily clipped on and abut in a hole such that the light 100 is not completely visible from outside and further, due to the battery 208, no electrical cords are required and therefore, hundreds of devices 100 can be used in close proximity as decorations.

FIG. 3 illustrates a perspective view showing the LED decorative lighting in an assembled form with the cover being removed to disclose the electrical components in accordance with the disclosed architecture. As illustrated, the decorative lighting device 100 has the removable plastic cover 104 for accommodating the LED 106. The LED 106 can be removed from the cover 104 when it is required to be replaced. The wired-connection between the LED 106 and the battery 208 are removable enabling a user to easily change or replace the LED 106 and/or the battery 208. The timer chip 204 is fixedly positioned inside the housing 102 and the battery 208 is removably positioned on the chip 204.

It should be noted that the LED 106 remains fixed to the cover 104 when the cover 104 is removed to access the housing 102. Further, the battery 208 can be Li-Ion as described earlier or can be any conventional small size or button battery as per design requirements of the lighting device 100.

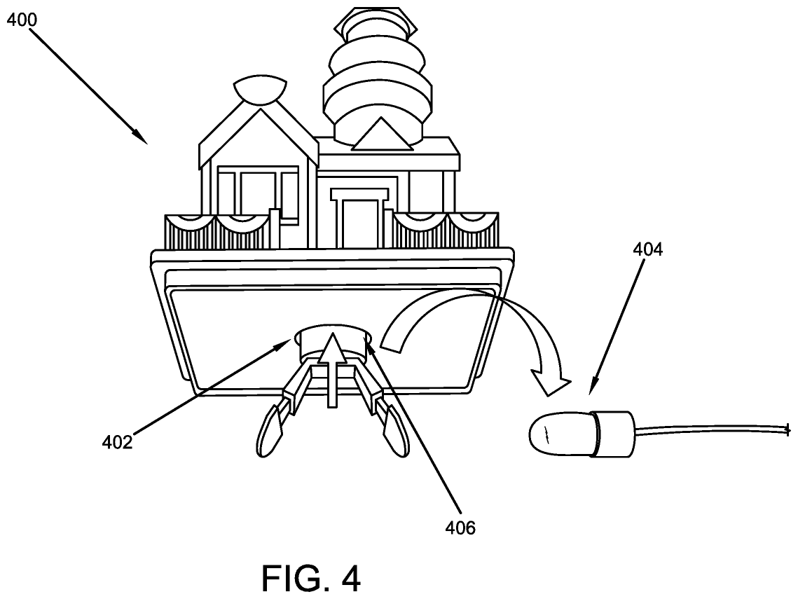

FIG. 4 illustrates a perspective view showing the LED lighting device 100 being inserted into a hole of a ceramic display device in accordance with the disclosed architecture. The lighting device 100 can be inserted easily into a hole 402 of a decorative item 400 such as a ceramic display device. The lighting device 100 is configured and designed to replace existing illuminating sources 404 having integrated wires. For inserting the lighting device 100, the LED 106 and housing 102 is inserted along a perimeter of the hole 402 such that cover 104 and the housing 102 are accommodated inside the hole and the graduated indentations 114 abut the hole walls 406 to secure the light 100 inside the hole 402.

The lighting device 100 can be illuminated by a user before inserting along a perimeter of the hole 402 such as by using the switch disposed on the housing 102. Alternatively, the lighting device 100 can be operated remotely using the remote-control device as described later in the disclosure. The decorative lighting 100 provides a cleaner look to the decorative item 400 and is further, safe for individuals and pets. The lighting device 100 also eliminates manual switching on and off of the light 100 by a user due to a built-in timer.

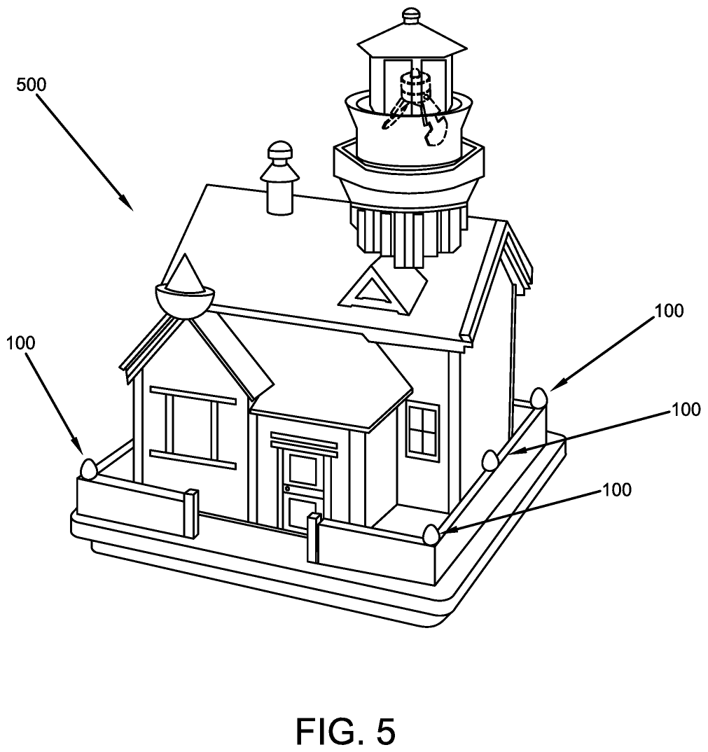

FIG. 5 illustrates a perspective view of a Christmas village display equipped with a plurality of the decorative lighting 100 of the present invention in accordance with the disclosed architecture. The Christmas village display 500 is generally used during Christmas season and is used for decorating all types of premises. Conventional displays 500 have a plurality of openings or holes in which the LED decorative lighting 100 of the present invention are accommodated in a manner described in other embodiments of the present invention.

It should be noted that a plurality of lighting devices 100 can be incorporated with each light using its integrated battery for electrical power and thus eliminating requirements of electrical cords and ensuring safety and cleanliness.

FIG. 6 illustrates a schematic view showing connection of the lighting device and a remote-control device for remote operation and control of the lighting device in accordance with the disclosed architecture. The lighting device 100 is configured to be connected to a remote-control device 602 via a low energy Bluetooth channel 604. The Bluetooth channel 604 is established using the wireless transceiver 206 of the device 100 and an embedded Bluetooth chip of the remote-control device 602. The remote-control device 602 can be a physical remote device or can be in the form of a digital device having a digital display for configuring and monitoring the lighting device 100. In some embodiments, the remote-control device 602 can be a smartphone having an installed computer implemented application providing an interface to control the lighting device 100.

The remote-control device 602 provides a timer value control 606 configured to adjust the timer value duration for turning ON the LED in the lighting device 100. It should be noted that timer chip is configured with the timer value set by the remote-control device 602. The LED turns ON for the duration set in the timer value and is automatically turned OFF after the duration. In some embodiments, the LED is turned ON again after a time duration (i.e., 24 hours—timer cycle value) thereby eliminating manual intervention of a user. Alternatively, the LED can be turned ON again manually by a user.

The remote-control device 602 has color control 608 enabling a user to change illuminating color of the LED disposed in the lighting device 100. The color change is immediately reflected in the LED and gives a customized look. A power button 610 is disposed for remotely turning ON and OFF the LED eliminating a user to physically turn on and off the lighting device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lighting device”, “decorative lighting”, “device”, “light”, and “LED-operated decorative lighting” are interchangeable and refer to the LED-operated decorative lighting device 100 of the present invention.

Notwithstanding the forgoing, the LED-operated decorative lighting device 100 of the present invention can be of any suitable size and configuration as is known in the art without affecting the overall concept of the invention, provided that it accomplishes the above-stated objectives. One of ordinary skill in the art will appreciate that the LED-operated decorative lighting device 100 as shown in the FIGS. are for illustrative purposes only, and that many other sizes and shapes of the LED-operated decorative lighting device 100 are well within the scope of the present disclosure. Although the dimensions of the LED-operated decorative lighting device 100 are important design parameters for user convenience, the LED-operated decorative lighting device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An LED decorative lighting comprising:
a lighting device having a housing including a replaceable LED light, a cover, and a metal retention biasing clip for inserting said lighting device into an opening of a decorative fixture;
wherein said cover having a threaded fastener for removably securing to said housing;
wherein said replaceable LED light integrated with said cover;
wherein said metal retention biasing clip having a pair of legs positioned at a bottom end of said housing; and
further wherein said pair of legs each having a graduated indentation for securing to a perimeter of said opening of said decorative fixture.

2. The LED decorative lighting of claim 1, wherein said decorative fixture selected from a group consisting of a Christmas house, a Halloween decoration, and a nightlight.

3. The LED decorative lighting of claim 1, wherein said opening comprises a diameter from about 1 inch to about 2 inches.

4. The LED decorative lighting of claim 1, wherein said housing having an ‘ON/OFF’ switch for activating/deactivating a power supply to said replaceable LED light.

5. The LED decorative lighting of claim 4, wherein said lighting device comprises a remote-control device for operating said ‘ON/OFF’ switch remotely.

6. The LED decorative lighting of claim 1, wherein said metal retention biasing clip is integrally molded to a bottom surface of said housing.

7. The LED decorative lighting of claim 6, wherein said pair of legs is compressible inward towards one another for enabling insertion into said opening.

8. The LED decorative lighting of claim 7, wherein said pair of legs bias outward upon release of the compression for securing said metal retention biasing clip to said perimeter of said opening of said decorative fixture.

9. An LED decorative lighting comprising:
a lighting device having a housing including a replaceable LED light, a cover, and a metal retention biasing clip for inserting said lighting device into an opening of a decorative fixture;
wherein said cover having a threaded fastener for removably securing to said housing;
wherein said replaceable LED light integrated with said cover;
wherein said metal retention biasing clip having a pair of legs positioned at a bottom end of said housing;
wherein said pair of legs each having a graduated indentation for securing to a perimeter of said opening of said decorative fixture; and
further wherein said lighting device having a timer chip and an embedded wireless transceiver for controlling said lighting device using a remote-control.

10. The LED decorative lighting of claim 9, wherein said timer chip is an application specific integrated circuit having a relay circuit for programming a timer value duration for illuminating said replaceable LED light.

11. The LED decorative lighting of claim 9, wherein said timer chip is an integrated circuit having a relay circuit for programming a timer value duration for illuminating said replaceable LED light.

12. The LED decorative lighting of claim 10, wherein said housing comprises a rechargeable battery for powering said replaceable LED light.

13. The LED decorative lighting of claim 12, wherein said cover is comprised of a translucent plastic.

14. The LED decorative lighting of claim 12, wherein said cover is comprised of a transparent plastic.

15. An LED decorative lighting comprising:
a lighting device having a housing including a replaceable LED light, a cover, and a metal retention biasing clip for inserting said lighting device into an opening of a decorative fixture;
wherein said cover having a threaded fastener for removably securing to said housing;
wherein said replaceable LED light integrated with said cover;
wherein said metal retention biasing clip having a pair of legs positioned at a bottom end of said housing;
wherein said pair of legs each having a graduated indentation for securing to a perimeter of said opening of said decorative fixture;
wherein said lighting device having a timer chip and an embedded wireless transceiver for controlling said lighting device using a remote-control;
wherein said timer chip is an integrated circuit having a relay circuit for programming a timer value duration for illuminating said replaceable LED light;
wherein said housing having a rechargeable battery for powering said replaceable LED light; and
further wherein said rechargeable battery having power from about 4V to about 5V.

16. The LED decorative lighting of claim 15, wherein said decorative fixture is selected from a group consisting of a Christmas house, a Halloween decoration, and a nightlight.

17. The LED decorative lighting of claim 15, wherein said opening comprises a diameter from about 1 inch to about 2 inches.

18. The LED decorative lighting of claim 15, wherein said housing comprises an ‘ON/OFF’ switch for activating/deactivating said rechargeable battery to said replaceable LED light.

19. The LED decorative lighting of claim 18, wherein said lighting device comprises a remote-control device for operating said ‘ON/OFF’ switch remotely.

20. The LED decorative lighting of claim 19, wherein said pair of legs are compressible inward towards one another for enabling insertion into said opening, and further wherein said pair of legs are biased outward upon release of the compression for securing said metal retention biasing clip to said perimeter of said opening of said decorative fixture.
